(19) United States
(12) Patent Application Publication
(10) Pub. No.: US 2007/0085846 A1
(43) Pub. Date: Apr. 19, 2007

(54) Projector and method for issuing display authority token to computers from the same

(75) Inventors: Chih-Wei Yang, Rende Township (TW); Chih-Yang Wang, Jhonghe City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/543,265

(22) Filed: Oct. 5, 2006

(30) Foreign Application Priority Data
Oct. 7, 2005 (TW) 94135277

(51) Int. Cl. G09G 5/00

(52) U.S. Cl. 345/204

(57) ABSTRACT

A projector for selectively connecting to a number of computers is disclosed. The projector includes an access-point module and a projection module. The access-point module is for issuing a display authority token to one of the computers connected to the projector in response to a computer request for the display authority token. The project module is for projecting a video data of the computer with the display authority token.

This application claims the benefit of Taiwan application Serial No. 94135277, filed Oct. 7, 2005, the subject matter of which is incorporated herein by reference.

### BACKGROUND OF THE INVENTION

1. Field of the Invention

The invention relates in general to a projector, and more particularly to a projector for issuing a display authority token to the computers connected to the same.

2. Description of the Related Art

Nowadays projectors have been an essential electronic product in a conference room. Lots of technical reports and analysis are displayed on a screen via a projector.

Projectors can be divided into two classes, one is network connectible, and the other is not network connectible. The not-network-connectible projector performs an image transmission operation via an interface connector such as DVI or HDMI. Supposed there are many users who take turns to make a report by using a not-network-connectible projector in a conference room. They need to connect their own computers to a connector of the not-network-connectible projector before they make a report. For this reason, it will waste much time and damage the connecter more easily to have the connector of the network-connectible projector inserted to and unplugged from the computers.

Compared to the not-network-connectible projector, the network-connectible projector performs a relatively simpler operation. The network-connectible projector manages report orders via a manager such that each user's computer takes turns to be coupled to the network-connectible projector for report. However, in practical application, it still needs a manager to perform a complicated mechanism of authority control, arbitration and connection management. Therefore, it is still not easy for the present network-connectible projector to have a practical management and it is also difficult to find a skilled person to perform authority settings in a practical operation, thereby causing usage inconvenience of the projector.

### SUMMARY OF THE INVENTION

It is therefore an object of the invention to provide a projector. The users can take turns easily to transmit frames of their computers to the projector according to the practical conference orders without need of an extra manager for performing complicated authority control.

The invention achieves the above-identified object by providing a projector for selectively connecting to a number of computers is disclosed. The projector includes an access-point module and a projection module. The access-point module is for issuing a display authority token to one of the computers connected to the projector in response to a computer request for the display authority token. The project module is for projecting a video data of the computer with the display authority token.

The invention achieves the above-identified object by providing a method for establishing a video data communication among a projector and a plurality of computers. The projector is capable to issue a display authority token to one of the computers. The method comprises receiving by the projector a computer request for the display authority token sent from one of the computers; issuing by the projector the display authority token to the computer in response to the computer request, so as to establish the video data communication with the computer with the display authority token; and projecting, by the projector, the video data from the computer with the display authority token.

The invention achieves the above-identified object by providing a network communication system. The network communication system comprises a plurality of computers and a projector for selectively connecting to the computers. The projector comprises an access-point module and a projection module. The access-point module is for issuing a display authority token to one of the computers connected to the projector in response to a computer request for the display authority token. The projection module is for projecting the video data from the computer with the display authority token. Each of the computers is independently capable to send a computer request to the projector.

The invention achieves the above-identified object by providing a method for transmitting a first video data from a first computer and a second video data from a second computer to a projector. The first and the second computers are capable of being selectively un-authorized and authorized. The method comprises connecting the first computer, the second computer and the projector; making the first and the second computers un-authorized; sending, by the first computer, a computer request for a display authority token to the projector; issuing, by the projector, the display authority token to the first computer to make the first computer authorized; sending the first video data from the first computer being authorized to the projector, and the projector projecting the first video data; and sending, by the second computer, a computer request for the display authority token to the projector, after the first computer stops sending the first video data to the projector.

The invention achieves the above-identified object by providing a method for transmitting a video data of one of a plurality of computers to a projector. The method comprises connecting the computers and the projector; synchronously outputting a format from the computers and the projector; detecting, by each of the computers, whether a display authority token from the projector is received; making, by one of the computers which does not receive the display authority token, a computer request for the display authority token; sending the computer request to the projector; receiving, by the computer, the display authority token from the projector; waiting for, by the computer with the display authority token, a projector request for a refresh video data from the projector; and sending a video data from the computer with the display authority token to the projector in response to the projector request.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of connection between a projector and a number of computers in a conference room.

FIG. 2 is a flow chart for outputting frames from computers.

FIG. 3 is a flow chart of the method for the projector to connect with computers.

FIG. 4 is a flow chart of the method for operating the system of computers and a projector.

### DETAILED DESCRIPTION OF THE INVENTION

A network communication system includes a projector and a number of computers. In the network communication system, each of the computers is independently capable to send a computer request for the display authority token to the projector. Each computer can be connected to the projector on wire or by a wireless way.

The projector includes an access-point module and a projection module. The projection module includes a chassis, a digital micro-mirror device (DMD), a color wheel etc. to perform light propagation and separation. The access-point module is for performing signal transmission and reception and controlling the number of the computers connected to the projector to be less than a predetermined limitation. In the embodiment, the users use the computers to send respectively a computer request for the display authority token to the access-point module in order to transmit a video data prepared for display via the projection module. In the following description, an example is taken to illustrate how the projector makes a video data communication with the computers and how the computers take turns to output the video data thereof.

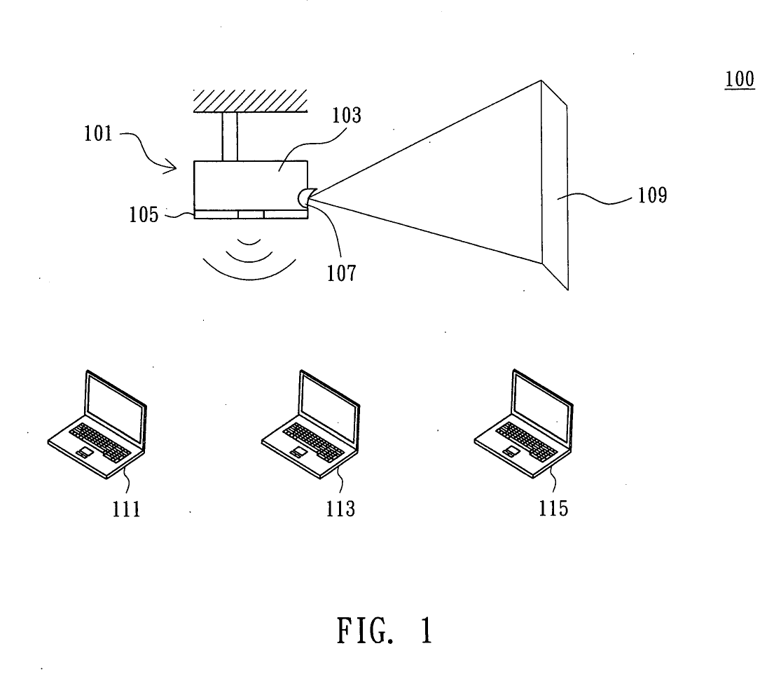

Referring to FIG. 1, a schematic diagram of connection between a projector and a number of computers in a conference room is shown. In the network communication system 100, the projector 101 includes a projection module 103 and an access-point module 105. The projection module 103 includes a light source, chassis, DMD, color wheel and lens. As shown in FIG. 1, a frame is projected on a screen 109 via the lens 107. The access-point module 105 is for transmitting and receiving signals. Supposed there are three persons taking turns to report in a conference room, who are respectively the first user, the second user and the third user. The three persons respectively prepare the first computer 111, the second computer 113 and the third computer 115. If the report orders in the conference are the first user, the second user and the third user, through connection and authority management of the projector 101 of the embodiment, the three users can easily transmit a video data from their computers to the projector 101 without additional managers, so as to save conference time.

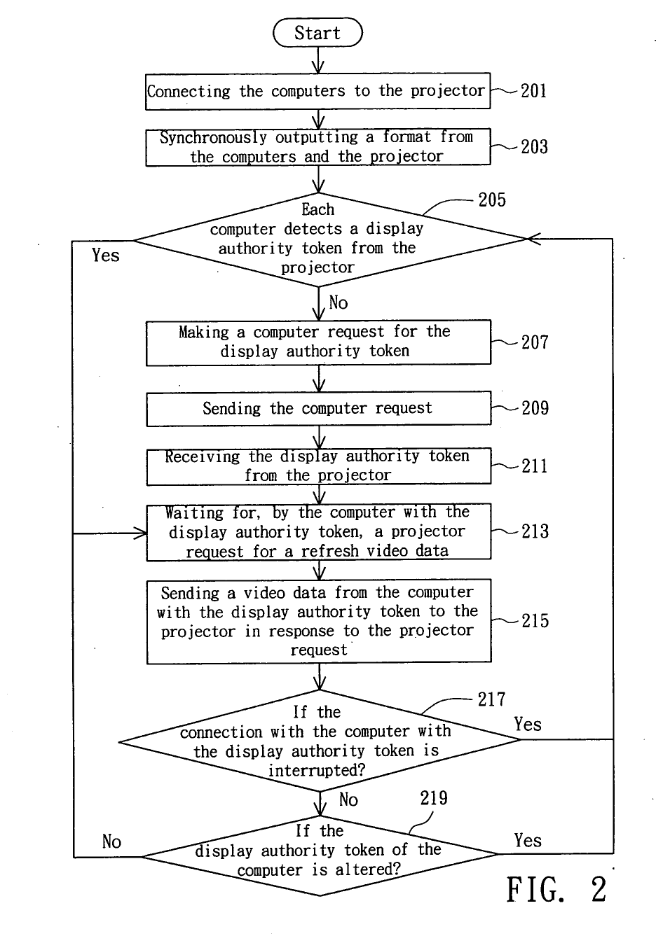

Referring to FIG. 2, a flow chart for outputting frames from computers is shown. First, in step 201, three computers 111, 113 and 115 are connected to the projector 101 via network connection (assumed within the predetermined limitation). Next, in step 203, the three computers 111, 113 and 115 and the projector 101 synchronously output a format. Then, in step 205, each of the three computer 111, 113 and 115 detects whether a display authority token from the projector 101 is received. If yes, one of the three computer 111, 113 and 115 which receives the display authority token waits for a projector request for a refresh video data from the projector 101 in the step 213. In step 215, the computer with the display authority token sends its video data in response to the projector request. Afterwards, in step 217, the projector 101 detects whether the connection with the computer with the display authority token is interrupted. If the connection is interrupted, the step 205 is subsequently performed. And if the connection is not interrupted, the computer with the display authority token proceeds to the step 219 to detects whether the display authority token thereof is altered or the same. If the display authority token is altered, the step 205 is subsequently performed. And if the display authority token is the same, the step 213 is performed. The projector 101 projects only one video data from one of the three computers 111, 113, and 115 in practical application. That is, only one computer can receive the display authority token and thereby sent the video data for display to the projector. Therefore, among the present three computers 111, 113, and 115, two computers will not receive the display authority token and each of these two computers may continue to perform the step 207 to make a computer request for the display authority token if the users would like to obtain the display authority token yet. Supposed the first computer 111 receives the display authority token first in step 205, then the first computer 111 performs the step 213 to wait for a projector request for a refresh video data from the projector 101 and performs the step 215 to send out a video data next. As for the second computer 113 and the third computer 115, they can ask for the display authority token only after the first computer 111 has finished displaying according to the conference ethics. When the first user finishes using the first computer 111, the second user can use the computer 113 to make the computer request for the display authority token, that is, the second computer 113 will perform the step 207. Then, the second user can use the computer 113 to send the computer request to the projector 101 in step 209, or not to send out the computer request by returning to the step 205. Following that, in step 211, the second computer 113 receives the display authority token from the projector 101 and send its video data in the following steps 213 and 215.

In the step 207, each of the second computer 113 and the third computer 115 will display a button or icon representative of the computer request for the display authority token on its screen. According to the conference ethics, if the first user finishes the report, the second user needs only to select the button or icon on the screen of the second computer 113 by cursor to receive the display authority token instead of the first user. In the same way, the third user can wait until the second user finishes the report and then select the button or icon on the screen of the third computer 115 by cursor to receive the display authority token. In a conference, the next user only needs to wait for the previous user to finish reporting and select the button or icon by cursor on his/her own computer to display the video data via the projector.

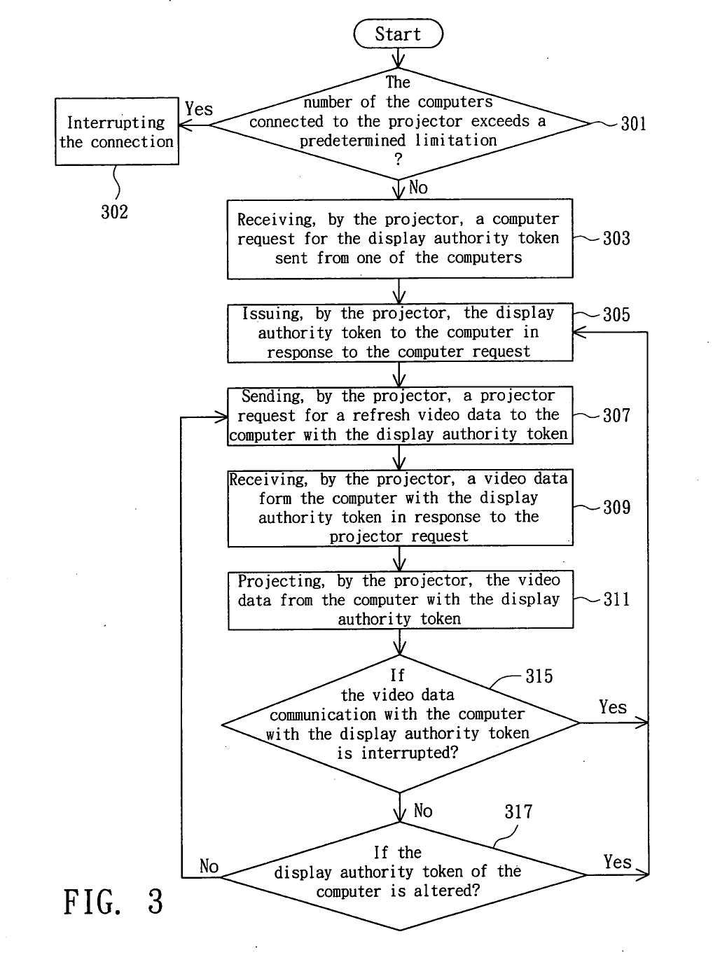

The above-mentioned process shows how to transmitting a video data of one of the computers to the projector. In the following description, a process for performing network connection and frame display operation is illustrated from a point view of the projector. The projector 101 as turned on will perform the following steps. Referring to FIG. 3, a flow chart of the method for the projector to connect with computers is shown. First, in step 301, the projector 101 detects whether the number of the computers connected to the projector 101 exceeds a predetermined limitation. As mentioned above, If the number does not exceed limitation, the projector 101 would synchronously outputs a format with the computers in connection, or the projector 101 will interrupt the connection in the step 302. Then, in step 303, the projector 101 receives a computer request for the display authority token sent from one of the computers 111, 113, and. Afterward, in step 305, the projector 101 issues the display authority token to one of the computer 111, 113, and 115 in response to the computer request, so as to establish the video data communication with the computer with the display authority token. Following that, in step 307, the projector 101 sends a projector request for a refresh video data to the computer with the display authority token. In step 309, the projector 101 receives a video data from the computer with the display authority token in response to the projector request. Then, in step 311, the projector 101 projects the video data from the computer with the display authority token. In step 313, the projector 101 detects whether the video data communication with the computer with the display authority token is interrupted. And if the video data communication is interrupted, the projector 101 performs the step 305. On the contrary, if the video data communication is not interrupted, the projector 101 proceeds to the step 315 to detect whether the display authority token of the computer is altered or the same. If altered, the projector 101 returns to the step 305 to establish the video data communication with some computer again. If the same, the projector 101 returns to the step 307 and 309.

Owing that every projector 101 has a limitation to the number of computers requesting for connection, the projector 101 will perform the steps 301 and 302 to control the amount of the computers in connection. If the number of computers which the projector 101 can be connected to is 4, take FIG. 1 as an example, and the three computers 111, 113 and 115 can be connected to the projector 101 at the same time. If the number of computers requesting for connection exceeds 4, the projector 101 will interrupt the connection of all the computers to the projector except for the first four computers in the step 302.

Moreover, each computer connected to the projector 101 will perform a synchronous output format operation with the projector 101 as mentioned in step 203. Meanwhile, the computers and projector 101 will test the system compatibility. For example, the projector 101 checks or coordinates parameters such as resolution and display frequency of output frames. In step 305, it can be designed that the computer which is foremost for connecting to the projector 101 can receive the display authority token. For example, in FIG. 1, if the first computer 111 is connected to the network computer 101 first, it can receive the display authority token.

In the steps 313 and 315, the projector 101 will detect the video data communication and the display authority token of the computer periodically. For example, after the first user finishes using the first computer 111 to report, the projector 101 interrupts the connection with the first computer 111 such that the video data communication is interrupted simultaneously. At this time, the projector 101 detects the interruption and returns to the step 305. If the second user makes the computer request for the display authority token, the projector 101 will issue the display authority token to the second computer 113.

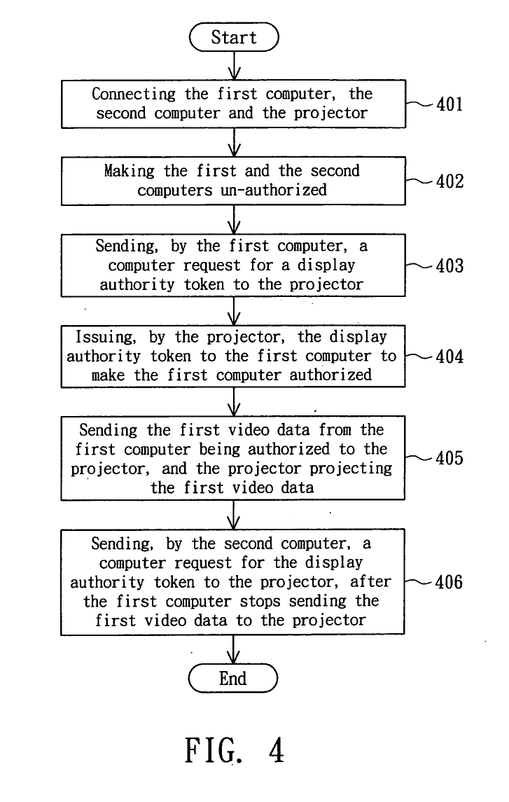

In terms of the network communication system 100, it executes the following steps. Referring to FIG. 4, a flow chart of the method for operating the system of computers and a projector is shown. Besides, it only takes the first and the second computers 111 and 113 to be exemplified for the purpose of convenience. The first and the second computers 111 and 113 are capable of being selectively un-authorized and authorized for the projector 101 as mentioned above. First, in the step 401, the first computer 111, the second computer 113 and the projector 101 are connected to each other. Then, in the step 402, the first and the second computers 111 and 113 are made un-authorized. Next, in the step 403, the first computer 111 sends a computer request for a display authority token to the projector 101. Then, in the step 404, the projector 101 issues the display authority token to the first computer 111 to make the first computer authorized. Next, in the step 405, the first video data are sent from the first computer 111 being authorized to the projector 101, and the projector 101 projects the first video data. Finally, in the step 406, the second computer 113 sends a computer request for the display authority token to the projector 101, after the first computer 111 stops sending the first video data to the projector 101. Similarly, the projector 101 issues the display authority token to the second computer 113 when the computer request is received.

According to the projector and method for issuing the display authority token to computers from the same disclosed by the above-mentioned embodiment of the invention, each user can just select the button or icon by cursor on the screen of his/her computer to receive the display authority token from the projector and directly transmit video data of the computer to the projector for projection in conference orders without extra authority managers. Therefore, the projector does not waste the conference time in connector insertion and unplug like the not-network-connectible projector and thus can improve the variety of product usage.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projector, for selectively connecting to a plurality of computers, the projector comprising:
an access-point module, for issuing a display authority token to one of the computers connected to the projector in response to a computer request for the display authority token; and
a projection module, for projecting a video data from the computer with the display authority token.

2. The projector according to claim 1, wherein the access-point module controls the number of the computers connected to the projector.

3. A method for establishing a video data communication among a projector and a plurality of computers, the projector capable to issue a display authority token to one of the computers the projector, the method comprising:
(a) receiving, by the projector, a computer request for the display authority token sent from one of the computers;
(b) issuing, by the projector, the display authority token to the computer in response to the computer request, so as to establish the video data communication with the computer with the display authority token; and
(c) projecting, by the projector, the video data from the computer with the display authority token.

4. The method according to claim 3, wherein before the step (a), the method further comprises:
detecting, by the projector, whether the number of the computers connected to the projector exceeds a predetermined limitation.

5. The method according to claim 3, wherein the method further comprises:
sending, by the projector, a projector request for a refresh video data to the computer with the display authority token; and
receiving, by the projector, a video data from the computer with the display authority token in response to the projector request.

6. The method according to claim 3, wherein the method further comprises:
detecting, by the projector, whether the video data communication with the computer with the display authority token is interrupted; and
if the video data communication is not interrupted, detecting by the projector whether the display authority token of the computer is altered or the same.

7. The method according to claim 6, wherein the method further comprises:
if the display authority token of the computer is the same, sending by the projector a projector request for a refresh video data to the computer with the display authority token; and
receiving, by the projector, a video data from the computer with the display authority token in response to the projector request.

8. The method according to claim 6, wherein the method further comprises:
if the display authority token of the computer is altered, issuing by the projector the display authority token to one of the computers which sends a computer request for the display authority token, so as to establishing the video data communication with the computer.

9. The method according to claim 6, wherein the method further comprises:
if the video data communication is interrupted, issuing by the projector the display authority token to one of the computers which sends a computer request for the display authority token, so as to establishing the video data communication with the computer.

10. A network communication system, comprising:
a plurality of computers; and
a projector, for selectively connecting to the computers, the projector comprising:
an access-point module, for issuing a display authority token to one of the computers connected to the projector in response to a computer request for the display authority token; and
a projection module, for projecting the video data from the computer with the display authority token;
wherein each of the computers is independently capable to send a computer request to the projector.

11. The network communication system according to claim 10, wherein the access-point module controls the number of the computers connected to the projector.

12. A method for transmitting a first video data from a first computer and a second video data from a second computer to a projector, the first and the second computers capable of being selectively un-authorized and authorized, the method comprising:
(a) connecting the first computer, the second computer and the projector;
(b) making the first and the second computers un-authorized;
(c) sending, by the first computer, a computer request for a display authority token to the projector;
(d) issuing, by the projector, the display authority token to the first computer to make the first computer authorized;
(e) sending the first video data from the first computer being authorized to the projector, and the projector projecting the first video data; and
(f) sending, by the second computer, a computer request for the display authority token to the projector, after the first computer stops sending the first video data to the projector.

13. The method according to claim 12, wherein in the step (f), the projector issues the display authority token to the second computer when the computer request is received.

14. A method for transmitting a video data of one of a plurality of computers to a projector, comprising:
(a) connecting the computers to the projector;
(b) synchronously outputting a format from the computers and the projector;
(c) detecting, by each of the computers, whether a display authority token from the projector is received;
(d) making, by one of the computers which does not receive the display authority token, a computer request for the display authority token;
(e) sending the computer request to the projector;
(f) receiving, by the computer, the display authority token from the projector;
(g) waiting for, by the computer with the display authority token, a projector request for a refresh video data from the projector; and
(h) sending a video data from the computer with the display authority token to the projector in response to the projector request.

15. The method according to claim 14, wherein after the step (h), the method further comprises:
detecting, by the projector, whether the connection with the computer with the display authority token is interrupted;
if the connection is not interrupted, detecting whether the display authority token of the computer is altered or the same; and
if the display authority token of the computer is altered, returning to the step (c).

16. The method according to claim 15, wherein the method further comprises:
if the connection is interrupted, returning to the step (c).

17. The method according to claim 15, wherein the method further comprises:
if the display authority token of the computer is the same, returning to the step (g).

18. The method according to claim 14, wherein the method further comprises:
if one of the computers detects the display authority token is received in the step (c), proceeding to the step (g).

19. The method according to claim 14, wherein the method further comprises:
detecting whether a computer request for the display authority token is sent to the projector; and
if no computer request is sent to the projector, returning to the step (c).
